(19) United States
(12) Patent Application Publication
(10) Pub. No.: US 2004/0214703 A1
(43) Pub. Date: Oct. 28, 2004

(54) Punching and scoring backing plate, method for producing the backing plate, machine equipped with the backing plate and method for punching and scoring with the backing plate

(76) Inventors: Berthold Berens, Esche (DE); Jens Friedrichs, Neckargemund (DE); Thimo Pazdzior, Leimen (DE); Werner Voss, Nordhorn (DE)

Correspondence Address: LERNER AND GREENBERG, PA, P O BOX 2480, HOLLYWOOD, FL, 33022-2480, US

(21) Appl. No.: 10/766,593

(22) Filed: Jan. 28, 2004

(30) Foreign Application Priority Data
Jan. 28, 2003 (DE) 103 03 178.2

(51) Int. Cl. B31B 1/00

(52) U.S. Cl. 493/51

(57) ABSTRACT

A punching and scoring backing plate is formed of aluminum sheet metal. A method of producing the backing plate includes forming the backing plate of aluminum sheet metal. A machine for processing printing material includes the backing plate formed of aluminum sheet metal. A method for punching and scoring a printing material includes forming a punching and scoring backing plate of aluminum sheet metal, and punching and scoring the printing material with the backing plate.

### BACKGROUND OF THE INVENTION

Field of the Invention

The invention relates to a punching and scoring backing plate which is produced from a metal sheet. The invention furthermore relates to a method for producing a punching and scoring backing plate from a metal sheet. Additionally, the invention relates to a printing material-processing machine having a punching and scoring backing plate, and the invention also relates to a method for punching and scoring a printing material.

Within the context of the following description, it is to be understood that by punching there is meant both cutting with an uninterrupted cutting line as well as cutting with a regularly interrupted cutting line, i.e., perforating.

Punching and scoring backing plates serve as counterparts together with punching and scoring tools, typically for producing folding boxes. A punching and scoring tool has both a punching-line structure formed of at least one raised or elevated punching line as well as a scoring-line structure formed of at least one raised or elevated scoring line. A punching and scoring backing plate has a scoring groove structure formed of at least one scoring groove into which the material to be scored is pressed during scoring by the scoring-line structure. In addition, the punching and scoring backing plate has a surface into which the scoring groove structure is introduced and which rearwardly supports the material which is to be punched during punching.

If a blank, for example a folding box blank, is being punched out of the material, the punching-line structure is placed firmly on the surface of the punching and scoring backing plate, which wears over the course of time due to this shock-type loading. However, a measure that is taken with respect to the surface has already become known heretofore in order to maintain a sufficiently long service life of the punching and scoring backing plate. That measure has been described in German Published, Non-Prosecuted Patent Application DE 39 29 415 A1 and includes the production of the punching and scoring backing plate from a steel sheet having a surface which has been surface-hardened to a hardness of 42 to 56 HRC. The use of that steel sheet may indeed be advantageous with regard to service life but is disadvantageous with regard to the introduction of the scoring groove structure by milling and with regard to suitability for rotatively produced punching and scoring. Rotatively produced punching and scoring may be performed, for example, by the device described in German Published, Non-Prosecuted Patent Application DE 100 52 777 A1, and the introduction of a scoring groove structure by milling is mentioned in German Patent DE 196 10 574 C1, corresponding to U.S. Pat. No. 6,106,453.

Since steel is a comparatively hard material, it cannot be milled without considerable effort. Narrow limits are placed on the feed and the chip depth of the milling tool during steel machining, particularly because, when the scoring groove structure is produced, the milling tool must be appropriately filigreed with respect to the cross section of the scoring grooves.

Due to the comparatively high flexural rigidity of the steel material, a punching and scoring backing plate formed therefrom can be clamped onto a tool cylinder, as required for rotational punching and scoring, only if it is comparatively thin. A reduced thickness of the punching and scoring backing plate is beneficial with respect to the deformability or flexibility required for clamping, but not with regard to the scoring groove structure. If the plate thickness is too low, then the groove depth of the scoring groove structure is necessarily also low. However, a correspondingly deep scoring groove structure is necessary for scoring very thick materials, for example thick folding boxboard.

### SUMMARY OF THE INVENTION

It is accordingly an object of the invention to provide a punching and scoring backing plate, a method for producing the backing plate, a machine equipped with the backing plate and a method for punching and scoring with the backing plate, which overcome the hereinafore-mentioned disadvantages of the heretofore-known devices and methods of this general type and in which the method is relatively uncomplicated and is capable of punching and scoring printing material of relatively great thickness.

With the foregoing and other objects in view, there is provided, in accordance with the invention, a punching and scoring backing plate, comprising a sheet formed of metal. The metal sheet is an aluminum sheet.

In accordance with another feature of the invention, the aluminum sheet has a hard anodized top layer.

In accordance with a further feature of the invention, the top layer has a hardness of at least 350 HV 0.05 (Vickers Hardness).

In accordance with an added feature of the invention; the top layer has a thickness of at least 10 μm.

With the objects of the invention in view, there is also provided a method for producing a punching and scoring backing plate. The method comprises providing a metal sheet formed as an aluminum sheet for the backing plate.

In accordance with a further mode, the method of the invention further includes providing the aluminum sheet with a top layer by hard anodizing.

In accordance with an added mode, the method of the invention further includes introducing a scoring groove into the aluminum sheet to such a depth that the scoring groove completely penetrates the top layer and only incompletely penetrates a carrier layer lying under the top layer.

In accordance with an additional mode, the method of the invention further includes introducing the scoring groove into the aluminum sheet by milling.

With the objects of the invention in view, there is additionally provided a machine for processing a printing material. The machine comprises a punching and scoring backing plate formed of aluminum sheet metal.

With the objects of the invention in view, there is furthermore provided a method for punching and scoring a printing material. The method comprises forming a punching and scoring backing plate of aluminum sheet metal, and providing the backing plate for punching and scoring the printing material.

In accordance with another mode, the method is a rotatively operating method which further includes rotating the punching and scoring backing plate.

In accordance with a concomitant mode, the method of the invention further includes providing a printing material sheet as the printing material.

Thus, the punching and scoring backing plate according to the invention, is produced from a metal sheet which is an aluminum sheet.

The aluminum sheet is understood to be a sheet formed of aluminum or an aluminum alloy, for example AlMg₃ or AlMg. Since the aluminum sheet can be placed or bent around a tool cylinder much more readily than a steel sheet having a sheet thickness comparable to that of the aluminum sheet, the punching and scoring backing plate according to the invention is very well suited for its use for rotational punching and scoring.

With respect to features which are advantageous with regard to the service life of the punching and scoring backing plate, the aluminum sheet has a hard anodized top layer, the hardness of which is preferably at least 350 HV 0.05 (micro-hardness testing according to Vickers, note EN ISO 4516:2002) and the thickness of which is preferably at least 10 microns. This top layer can be a very wear-resistant aluminum oxide layer (Al₂O₃) having a hardness which is approximately constant over the thickness thereof. The metal sheet, the surface of which is improved by the hard anodizing, and which forms the punching and scoring backing plate, is not only very resistant with respect to shock and compressive loading exerted on the top layer by the punching line or lines, but also with respect to repeated bending of the metal sheet towards and away during the clamping of the punching and scoring backing plate to and the removal thereof from the tool cylinder. In spite of the many loading cycles associated with the bending, the punching and scoring backing plate maintains the dimensional stability thereof over a long time period. Due to the fact that the top layer is formed from the metal sheet material by the oxidation of the aluminum, this top layer is thus very firmly connected to the base material lying underneath, which is also referred to below as the carrier layer. Although the punching and scoring backing plate is described at this juncture as a multilayer plate, there is never any risk with regard thereto of the top layer separating from the carrier layer. That risk exists in other multilayer punching and scoring backing plates of the prior art (see German Patent DE 195 38 538 C1), wherein the top layer and the carrier layer are shaped separately from one another and are only thereafter connected to one another, for example by adhesive.

The method according to the invention for producing a punching and scoring backing plate from a metal sheet provides for the metal sheet to be an aluminum sheet. The aluminum of this sheet can, of course, contain one or more alloying elements, for example magnesium, as already noted above, for improving the characteristics of the aluminum. In any case, it is advantageous that the aluminum and an alloy thereof be respectively machinable with metal removal more simply, in order to produce the scoring groove structure, than would be the case with steel.

A top layer, with which the aluminum sheet can be provided by hard anodizing in accordance with one feature or mode, is very thin, with preferably at most 150 microns and, for example, at most 50 microns layer thickness, and does not make the metal-removing machining noticeably more difficult. In a development or mode which is advantageous with regard to the dimensional stability of the punching and scoring backing plate, one or each scoring groove is introduced into the aluminum sheet to such a depth that the scoring groove completely penetrates the top layer, and only incompletely passes through part of a carrier layer lying under the top layer. The scoring groove structure, which is introduced into the aluminum sheet only after the hard anodizing, therefore does not go through the entire thickness of the punching and scoring backing plate. Instead, at the base of the scoring groove structure there remains a residual thickness of the carrier layer which, for example, is at least 0.1 millimeter, so that the scoring groove structure has a base and is open only on one side. The base is advantageous with regard to a use of the punching and scoring backing plate as a cylinder cover.

The punching and scoring backing plate has to be clamped onto an impression cylinder for the purpose of rotational punching and scoring. When the punching and scoring backing plate is clamped on, it is subjected to bending and clamping forces which entail the risk that the punching and scoring backing plate will curve or curl up in the vicinity of scoring grooves that extend axially parallel with the impression cylinder if these scoring grooves were to be produced as through-holes, i.e., without the base. However, since these scoring grooves are instead manufactured as blind holes according to the development or mode described herein, assurance is offered that the punching and scoring backing plate will not warp when it is clamped on. Due to the fact that the or each scoring groove is introduced into the aluminum sheet by milling, very dimensionally accurate fabrication of the groove profile and, in particular, of the base of the groove is possible.

The machine according to the invention for processing a printing material has a punching and scoring backing plate which is formed as an aluminum sheet or is produced from an aluminum sheet. The machine having the punching and scoring backing plate according to the invention can be a special machine used exclusively for punching and scoring carried out off-line. Instead, however, the machine can also be a printing press which, in addition to at least one printing unit, also includes a punching unit that is equipped with the punching and scoring backing plate according to the invention. In such a printing press, the printing material is, for example, first printed within an in-line process and then punched and scored. The printing unit can be an offset printing unit or a flexographic printing unit that is used, for example, as a varnishing unit.

The method according to the invention for punching and scoring a printing material, calls for the provision of a punching and scoring backing plate formed as an aluminum sheet or produced from an aluminum sheet and/or a machine equipped with this punching and scoring backing plate.

Through the use of this method, even comparatively thick printing material may be scored without difficulty, because the aluminum sheet permits a great groove depth of the scoring groove structure due to the characteristics or properties of the material thereof, and is nevertheless flexible.

The flexibility of the aluminum sheet is advantageous with regard to a development wherein the method is performed as a rotational processing method, wherein the punching and scoring backing plate rotates together with the impression cylinder whereon the punching and scoring backing plate is fixed. The printing material used in the method according to the invention for punching and scoring may be a printing material web and is preferably a printing material sheet, for example a board or carton sheet for folding box production.

Other features which are considered as characteristic for the invention are set forth in the appended claims.

Although the invention is illustrated and described herein as embodied in a punching and scoring backing plate, a method for producing the backing plate, a machine equipped with the backing plate and a method for punching and scoring with the backing plate, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, side-elevational view of a machine having a tool cylinder for punching and scoring, and an impression cylinder cooperatively assigned to the tool cylinder;

FIG. 2 is an enlarged, fragmentary, sectional view of FIG. 1, showing the tool cylinder with a punching and scoring tool plate fastened thereon, and the impression cylinder with a punching and scoring backing plate fastened thereon;

FIG. 3 is a further enlarged, fragmentary, sectional view of FIG. 2, showing the punching and scoring tool plate with a punching line and a scoring line, and the punching and scoring backing plate with a multilayer type of construction and a scoring groove;

FIG. 4 is a plan view of the punching and scoring tool plate removed from the tool cylinder;

FIG. 5A is a plan view of the punching and scoring backing plate removed from the impression cylinder;

FIG. 5B is a cross-sectional view of FIG. 5A, taken along the line VB-VB thereof in the direction of the arrows;

FIG. 6 is a fragmentary, cross-sectional view of the impression cylinder provided with a holding and clamping device for holding and clamping the punching and scoring backing plate;

FIG. 7 is an enlarged, fragmentary, side-elevational view of FIG. 1 showing the tool cylinder and the impression cylinder and, in cross section, a positioning aid for positioning the punching and scoring tool plate on the tool cylinder;

FIG. 8 is an enlarged, fragmentary, sectional view of FIG. 7 more clearly showing a gripper system of the impression cylinder for gripping a printing material sheet, as well as a portion of the holding and clamping device;

FIG. 9 is a plan view of the positioning aid shown in FIG. 7; and

FIG. 10 is a plan view of the tool cylinder.

### DESCRIPTION OF THE PREFERRED EMBODIMENTS

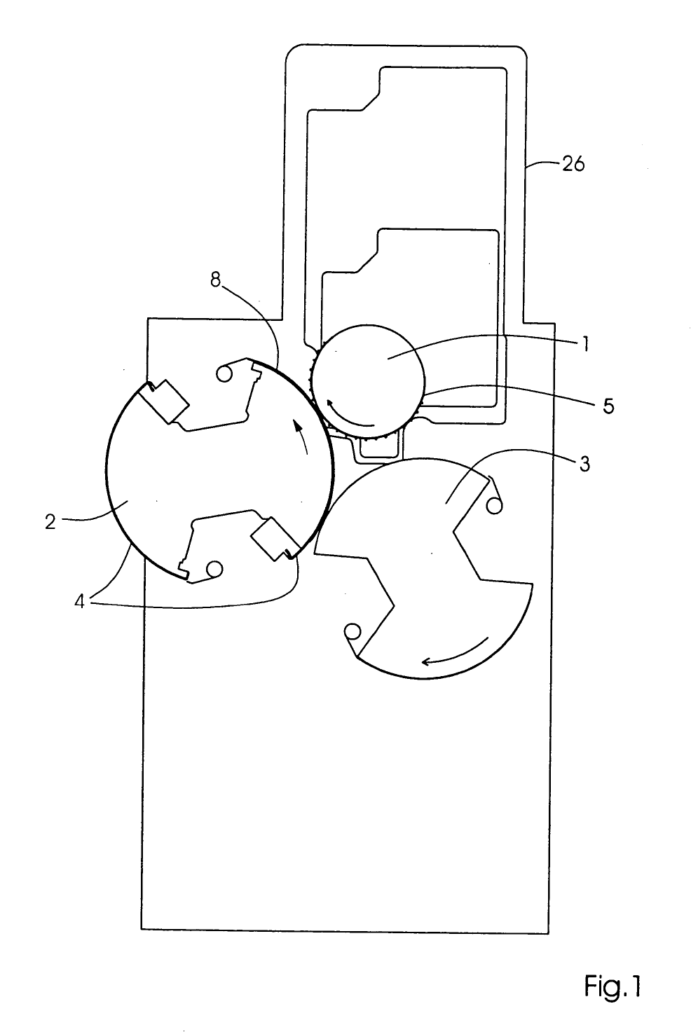

Referring now to the figures of the drawings in detail and first, particularly, to FIG. 1 thereof, there is seen a machine 26 for processing sheet printing material 8. The machine 26 is a printing press and includes a tool cylinder 1, an impression cylinder 2 and a sheet transport cylinder 3 which is disposed upstream from the impression cylinder 2, as viewed in sheet transport direction. A punching and scoring tool plate 5 is magnetically secured to the tool cylinder 1, and at least one punching and scoring backing plate 4 is fastened onto the impression cylinder 2.

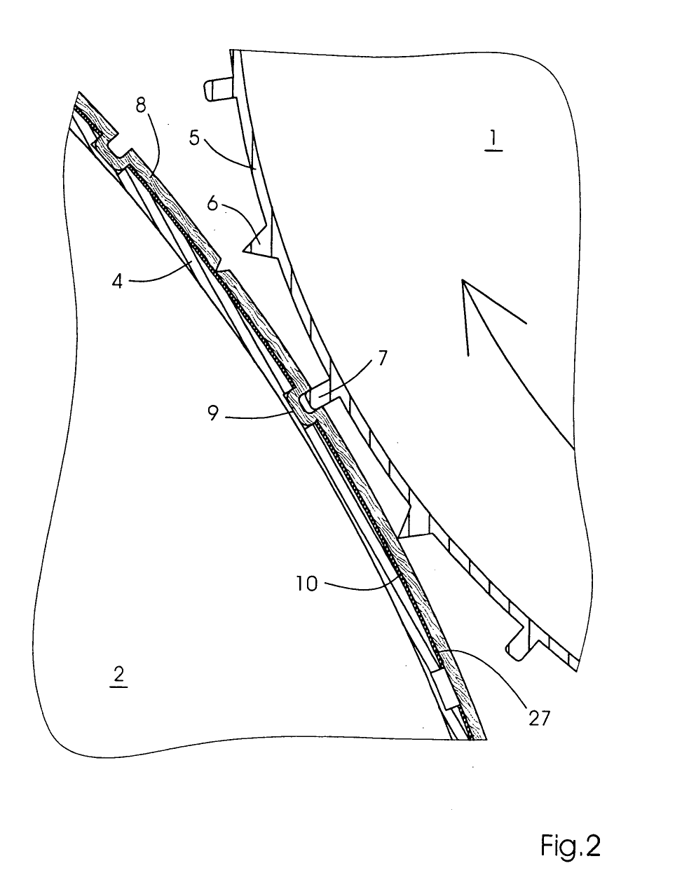

FIG. 2 is a fragmentary view of FIG. 1 in which it is more readily apparent how the printing material 8 rests on the punching and scoring backing plate 4 and is punched and scored in one and the same operation by the punching and scoring tool plate 5 rolling thereon. The punching and scoring tool plate 5, which is at least partly formed of a material that is magnetically attractable, for example steel, has at least one punching line 6 and at least one scoring line 7 as tool lines. The punching and scoring backing plate 4 is formed with a surface 27 into which at least one scoring groove 9 is introduced. During the punching and scoring of the printing material 8, the punching line 6, after it has cut through the printing material 8, is seated on the surface 27, and the scoring line 7 presses the printing material 8 simultaneously into the scoring groove 9.

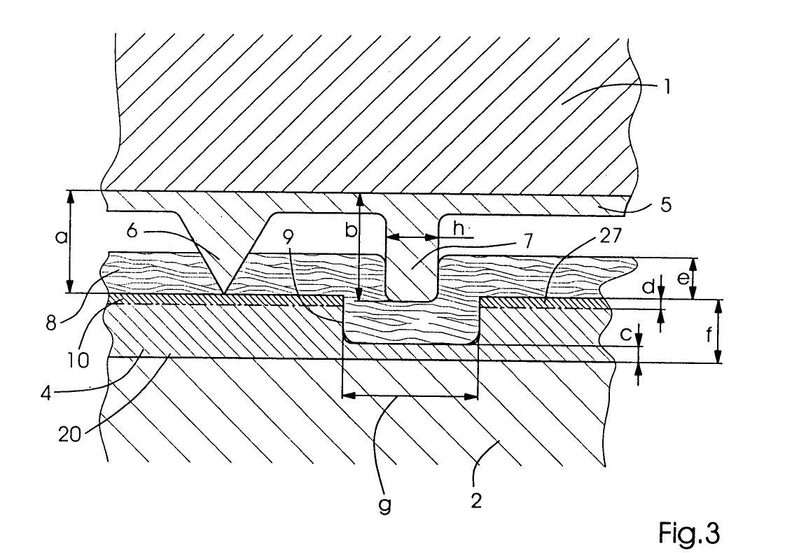

In the sectional view of FIG. 3, the punching and scoring backing plate 4 is shown as being double layered and having a comparatively hard top layer 10 provided with the surface 27. The top layer 10 is produced on a carrier layer 20 by hard anodizing and is formed of aluminum oxide. The top layer 10 has a hardness which is at least 350 HV 0.05 (Vickers Hardness) and preferably lies in a hardness range from 500 to 800 HV 0.05. The top layer 10 has a top layer thickness d which is at least 10 microns and preferably lies in a thickness range from 20 to 50 microns. The carrier layer 20 is comparatively soft and has a hardness lying in the hardness range from 50 to 80 HB (Brinell Hardness). The carrier layer 20 and the top layer 10 taken together have a plate thickness f which, in dimensional terms, lies in a range extending from 0.5 millimeter to 0.7 millimeter. The scoring line 7 has a scoring line height b which can be slightly higher than a punching line height a of the punching line 6. The scoring line 7 has a scoring line width h which is considerably less than a scoring groove width g of the scoring groove 9. The groove depth of the scoring groove 9 is less than the plate thickness f, so that the scoring groove 9 has a groove base with a base thickness c which is at least 0.1 millimeter. A printing material thickness e of the printing material 8 is greater than 0.3 millimeter. In this regard, it is noted that the printing material 8 is a very thick board or pasteboard sheet. The punching and scoring backing plate 4 has been fabricated from an aluminum sheet which is first hard anodized for the purpose of producing the top layer 10 formed of aluminum oxide, and then provided with the scoring groove 9 and further such scoring grooves by a metal-removing machining process, preferably milling. Since only a very limited portion is illustrated in FIG. 3, it is not possible to see that the two plates 4 and 5 are lying on the circumferential surfaces of the two cylinders 1 and 2 and are curved so as to fit snugly against these circumferential surfaces.

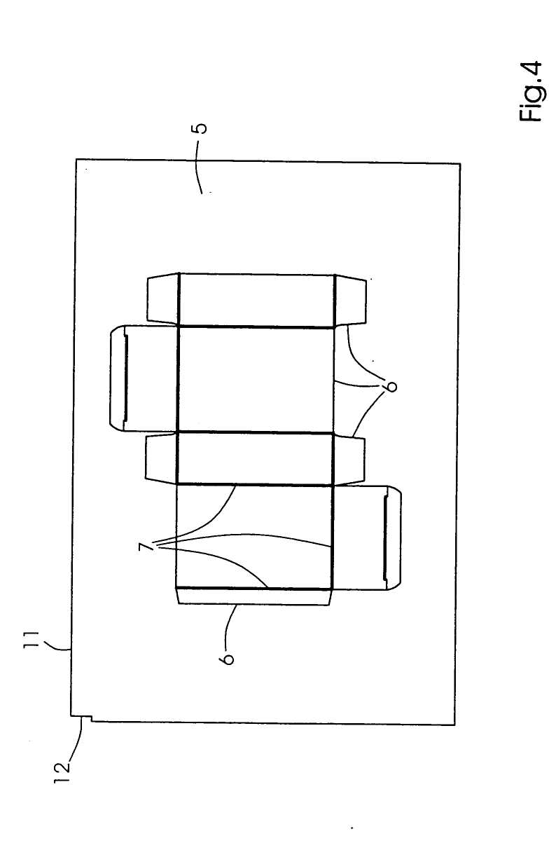

FIG. 4 illustrates a developed view of the punching and scoring tool plate 5, which has a leading edge 11 and a side edge 12. The aforementioned punching and scoring line structure for producing a folding box blank is believed to be readily apparent from this developed view.

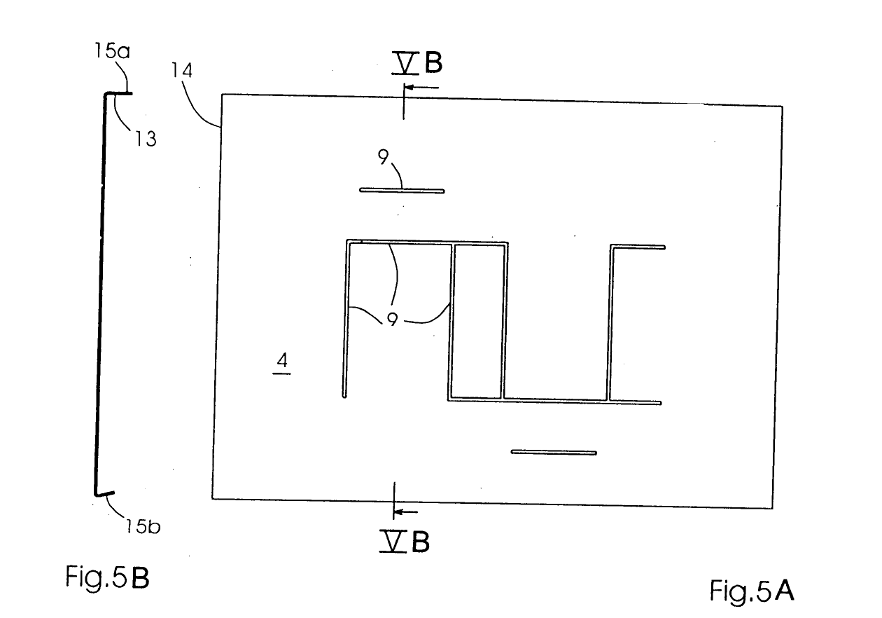

In FIG. 5A, the punching and scoring backing plate 4 is illustrated in a state in which it has been unwound from the impression cylinder 2. A comparison of FIG. 5A with FIG. 4 shows clearly that the scoring groove structure in FIG. 5A corresponds with the scoring lines 7 in FIG. 4 in a mirror-image manner.

FIG. 5B is a cross-sectional view of FIG. 5A taken along the line VB-VB in the direction of the arrows, wherein bent-over edges 15a and 15b serving as fastening hooks at the front and rear end of the punching and scoring backing plate 4 are shown. A front stop surface 13 (note FIG. 5B) and a lateral or side stop edge 14 (note FIG. 5A) of the punching and scoring backing plate 4, as well as the leading edge 11 and the side edge 12 (note FIG. 4), which likewise function as stop surfaces, of the punching and scoring tool plate 5, are used, firstly, for structuring the plates 4 and 5 so as to coincide with the lines and grooves and, secondly, for mutually corresponding positioning of the plates 4 and 5 on the respective cylinders 2 and 1.

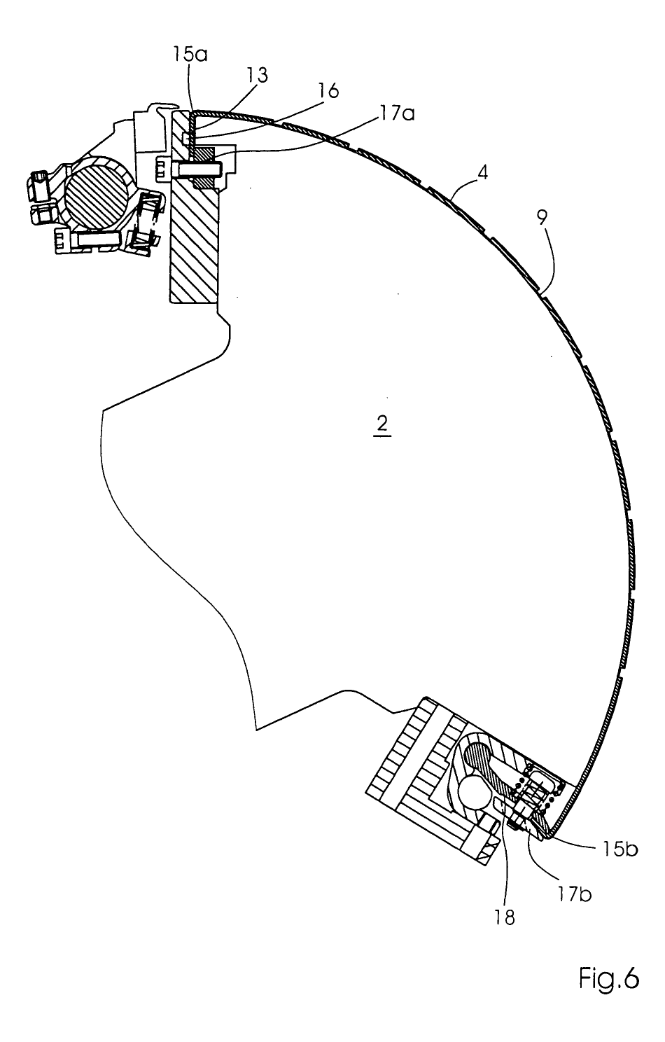

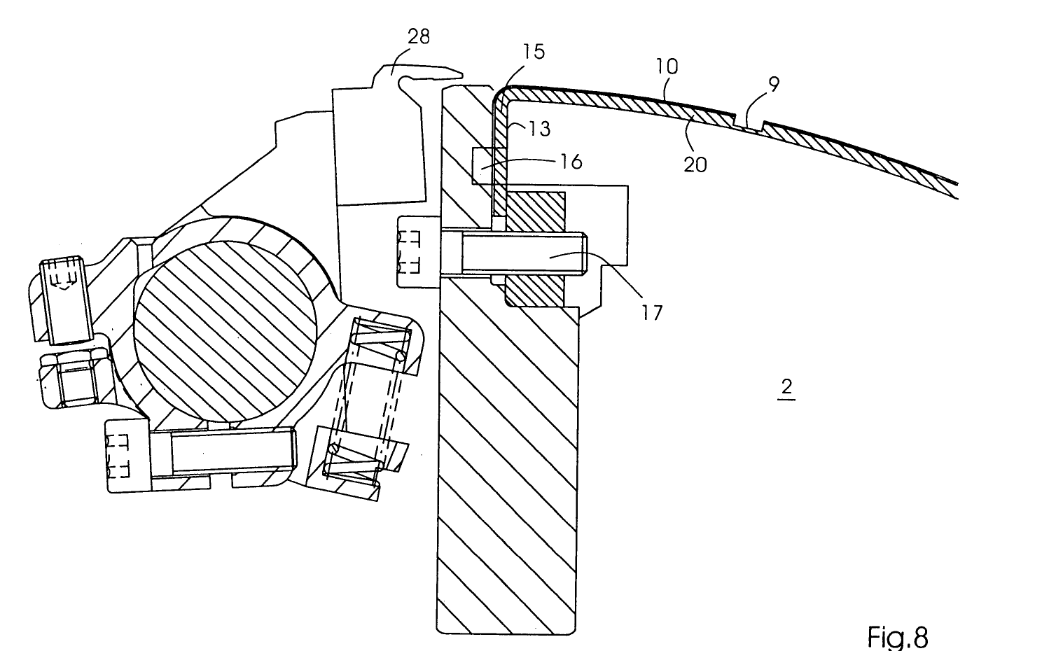

In FIGS. 6 and 8, a holding and clamping device is shown which includes a front clamping device 17a for firmly clamping the front bent-over edge 15a on the impression cylinder 2, and a rear clamping device 17b for firmly clamping the rear bent-over edge 15b on the impression cylinder 2. The rear clamping device 17b is mounted on a lever-like clamping element 18 which can be pivoted and by which the punching and scoring backing plate 4 can be pulled tautly onto the impression cylinder 2 in the circumferential direction and can be clamped. The front clamping device 17a has a stop 16 associated therewith for the surface of the side stop edge 14. In FIG. 8, there is shown diagrammatically a gripper system 28 disposed immediately before the front clamping device 17a in the circumferential direction of the cylinder 2 for clamping-in the printing material 8.

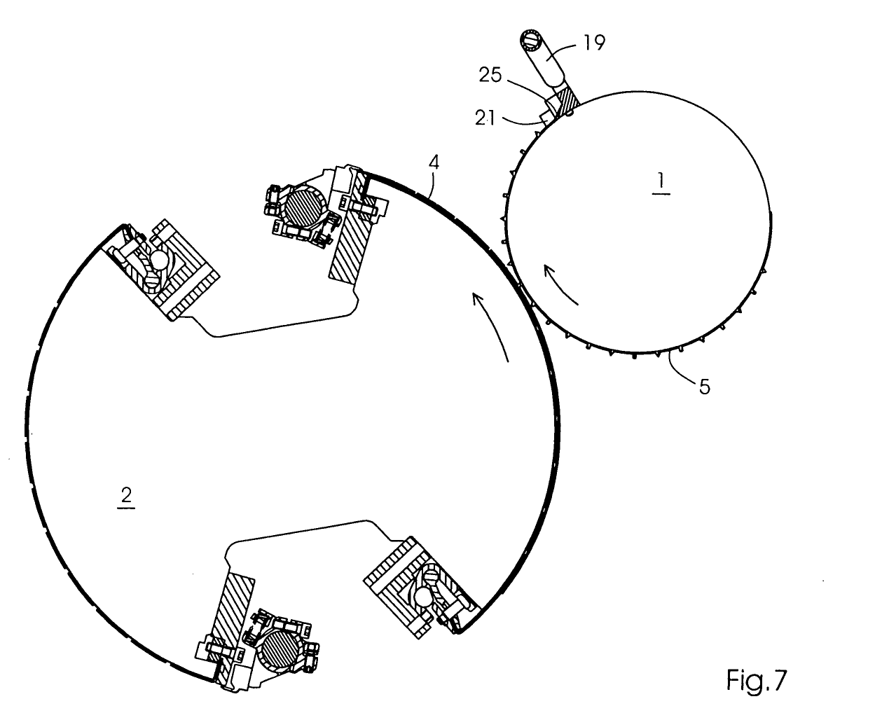

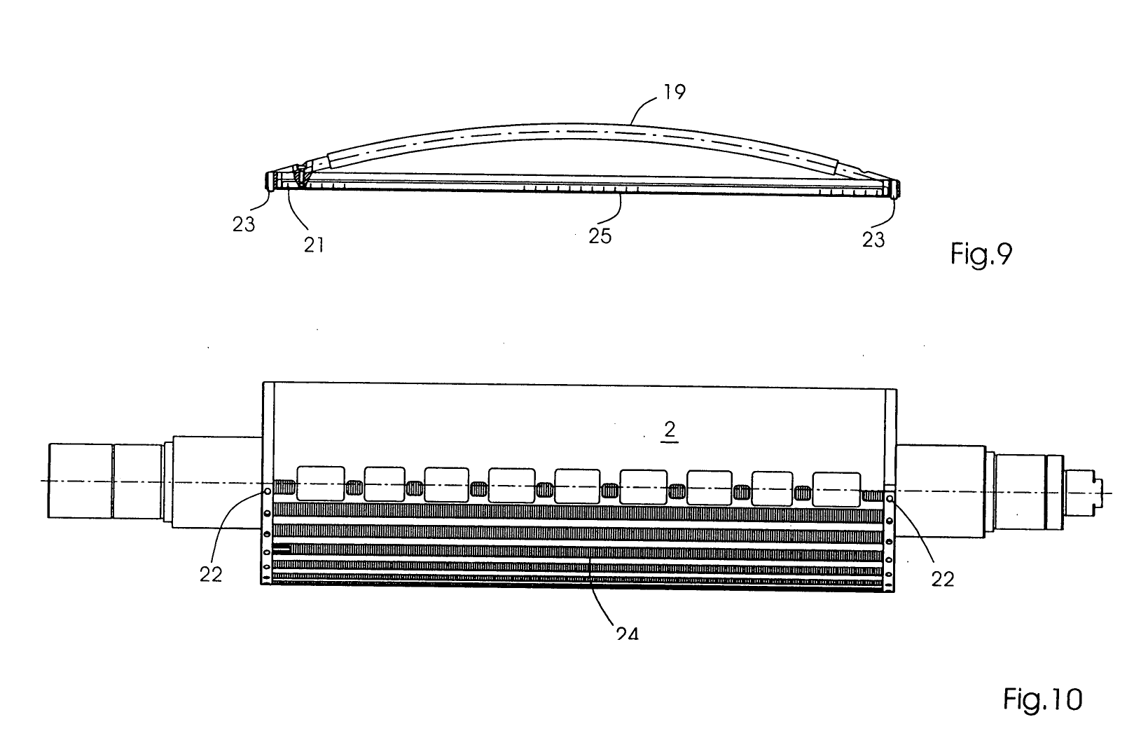

In FIGS. 7, 9 and 10, a positioning aid 19 with a positioning ruler or straight edge 25 is illustrated which, via index pins 23 which are fitted at the ends of the positioning aid 19, can be pushed together with the tool cylinder 1 temporarily for the purpose of positioning the punching and scoring tool plate 5 on the tool cylinder 1. For this purpose, the tool cylinder 1 is provided at each of the ends thereof with a row of index holes 22 extending in the circumferential direction, for the index pins 23. The positioning aid 19 has the following function:

After the positioning aid 19 has been pushed onto the tool cylinder 1, axially parallel with the latter, into one of the index holes 22, selected in accordance with the desired circumferential register, the punching and scoring tool plate 5 is placed with the leading edge 11 thereof over the entire edge length uniformly onto the positioning ruler 25. Through the use of a subsequent displacement of the punching and scoring tool plate 5 along the positioning ruler 25 which, in this regard, serves as a guide for the leading edge 11, into an end position, the lateral register of the punching and tool plate 5 is preset. The end position is determined by the engagement of the side edge 12 with a side stop 21 of the positioning aid 19. Only then is the punching and scoring backing plate pressed over the entire plate surface thereof against the tool cylinder 1, which is constructed as a magnetic cylinder. The tool cylinder 1 has a circumferential surface which is coated with a magnetically active material or preferably studded with magnets 24 (electromagnets or preferably permanent magnets). The magnets 24 hold the punching and scoring tool plate 5 firmly on the tool cylinder 1 in an operating position that is in accurate register.

We claim:

1. A punching and scoring backing plate, comprising:
a metal sheet, said metal sheet being formed of aluminum sheet metal.

2. The punching and scoring backing plate according to claim 1, wherein said aluminum sheet metal has a hard anodized top layer.

3. The punching and scoring backing plate according to claim 2, wherein said top layer has a hardness of at least 350 HV 0.05.

4. The punching and scoring backing plate according to claim 2, wherein said top layer has a thickness of at least 10 μm.

5. A method for producing a punching and scoring backing plate, which comprises producing the backing plate from a metal sheet formed of aluminum sheet metal.

6. The method according to claim 5, which further comprises providing the aluminum sheet metal with a top layer by hard anodizing.

7. The method according to claim 6, which further comprises providing a carrier layer lying under the top layer, and introducing a scoring groove into the aluminum sheet metal to a depth causing the scoring groove to completely penetrate the top layer and only incompletely penetrate the carrier layer.

8. The method according to claim 7, which further comprises carrying out the step of introducing the scoring groove into the aluminum sheet metal by milling.

9. A machine for processing a printing material, comprising a punching and scoring backing plate formed of aluminum sheet metal.

10. The machine for processing a printing material according to claim 9, wherein said aluminum sheet metal has a hard anodized top layer.

11. The machine for processing a printing material according to claim 10, wherein said top layer has a hardness of at least 350 HV 0.05.

12. The machine for processing a printing material according to claim 10, wherein said top layer has a thickness of at least 10 μm.

13. The machine for processing a printing material according to claim 10, wherein said aluminum sheet metal has a carrier layer lying under said top layer, and said aluminum sheet metal has a scoring groove completely penetrating said top layer and only incompletely penetrating said carrier layer.

14. A method for punching and scoring a printing material, which comprises forming a punching and scoring backing plate of aluminum sheet metal, and punching and scoring the printing material with the backing plate.

15. The method for punching and scoring a printing material according to claim 14, which further comprises carrying out the step of forming the backing plate by providing the aluminum sheet metal with a hard anodized top layer.

16. The method for punching and scoring a printing material according to claim 15, which further comprises providing the top layer with a hardness of at least 350 HV 0.05.

17. The method for punching and scoring a printing material according to claim 15, which further comprises providing the top layer with a thickness of at least 10 μm.

18. The method for punching and scoring a printing material according to claim 15, which further comprises providing a carrier layer lying under the top layer, and introducing a scoring groove into the aluminum sheet metal to a depth causing the scoring groove to completely penetrate the top layer and only incompletely penetrate the carrier layer.

19. The method for punching and scoring a printing material according to claim 14, which further comprises carrying out the step of punching and scoring the printing material with the machine according to claim 9.

20. The method according to claim 14, which further comprises rotating the punching and scoring backing plate in a rotatively operating process.

21. The method according to claim 14, which further comprises providing a printing material sheet as the printing material.
